(19) United States
(12) Patent Application Publication
(10) Pub. No.: US 2010/0142056 A1
(43) Pub. Date: Jun. 10, 2010

(54) OPTICAL FILTER AND METHOD OF MANUFACTURING THE SAME

(76) Inventors: Seung-Goo Baek, Suwon-si (KR); Sung-Yong Lee, Suwon-si (KR); Cha-Won Hwang, Suwon-si (KR); Sang-Mi Lee, Suwon-si (KR); Do-Hyuk Kwon, Suwon-si (KR)

Correspondence Address: CHRISTIE, PARKER & HALE, LLP, PO BOX 7068, PASADENA, CA, 91109-7068, US

(21) Appl. No.: 12/626,580

(22) Filed: Nov. 25, 2009

(30) Foreign Application Priority Data
Dec. 8, 2008 (KR) 10-2008-0123925

(51) Int. Cl. G02B 27/00; B05D 5/06; B05D 3/14; G02B 5/22

(52) U.S. Cl. 359/614; 427/162; 427/532; 359/885; 977/773; 977/762; 977/742

(57) ABSTRACT

An optical filter wherein a hard coating layer and an electromagnetic shielding layer are integrally formed and a method of manufacturing the optical filter. The optical filter includes a base film, and a hard coating layer formed on one surface of the base film, the hard coating layer having conductive substances positioned in a region adjacent to the base film. The method includes preparing a light-transmissive base film; coating a liquid hard coating raw material on one surface of the base film, the hard coating raw material having conductive substances mixed therewith; and curing the hard coating raw material in the state that the conductive substances are concentrated on a region adjacent to the base film, and the hard coating raw material is formed between and on the conductive substances.

### CROSS-REFERENCE TO RELATED APPLICATION

This application claims priority to and the benefit of Korean Patent Application No. 10-2008-0123925, filed on Dec. 8, 2008, in the Korean Intellectual Property Office, the entire content of which is incorporated herein by reference.

### BACKGROUND OF THE INVENTION

1. Field of the Invention

An aspect of the present invention relates to an optical filter including a hard coating layer and an electromagnetic shielding layer.

2. Description of Related Art

A plasma display device including a plasma display panel (PDP) is a flat panel display device which displays images utilizing a gas discharge phenomenon. In view of luminance, contrast, afterimage and viewing angle characteristics, the plasma display device is superior to a conventional cathode-ray tube (CRT).

Since high voltage and high frequency are used in a driving process of the aforementioned plasma display device, a large quantity of electromagnetic waves are radiated to the front of the PDP. Further, the plasma display device emits near infrared (NIR) radiation induced by an inert gas such as Ne or Xe. Such NIR radiation has a wavelength very close to that of a remote controller, thereby resulting in possible malfunctions of electric appliances. Furthermore, glass disposed in front of the PDP reflects external light, thereby resulting in glare, degradation of contrast or the like. Therefore, in most plasma display devices, a filter is provided in front of the PDP so as to compensate for these problems.

An optical filter used in a plasma display device may be a tempered glass filter or film-type filter having an electromagnetic shielding layer and a near infrared shielding layer. Recently, film-type filters utilizing a single material film have been used to decrease the price of plasma display devices.

A conventional film-type optical filter includes an anti-reflection layer, an electromagnetic shielding layer, a color correction layer and an adhesive layer. The anti-reflection layer is utilized to reduce (or prevent) external light from being reflected and to protect the filter and a panel from external environment. The electromagnetic shielding layer is made of a conductive substance having high electrical conductivity and formed beneath the anti-reflection layer. The electromagnetic shielding layer shields electromagnetic waves and reduces (or prevents) static charge.

### SUMMARY OF THE INVENTION

An aspect of an embodiment of the present invention is directed toward an optical filter wherein a hard coating layer and an electromagnetic shielding layer are integrally formed, so that a process of manufacturing the optical filter can be simplified, thereby increasing the yield of products and decreasing their price.

An aspect of an embodiment of the present invention is directed toward a method of manufacturing the aforementioned optical filter.

According to an embodiment of the present invention, there is provided an optical filter including a base film; and a hard coating layer formed on one surface of the base film, the hard coating layer having conductive substances positioned (or concentrated) in a region adjacent to the base film.

The conductive substances may have a specific gravity greater than that of a hard coating raw material forming the hard coating layer. The hard coating raw material may include a fluorine-based polymer compound. The hard coating layer may be formed to have a thickness of ¼ of the wavelength (λ) of a light passing therethrough on the base film.

The conductive substances may include conductive polymers or metal-based nano particles. The conductive substances may have a chain structure. The conductive substances may include a material selected from the group consisting of polyanillines, polycarbonates, carbon nano tubes, carbon nano wires, and combinations thereof.

The optical filter may further include a color coating layer formed on the one surface of the base film or another surface of the base film opposite to the one surface of the base film.

The hard coating layer may be an anti-reflection layer, and/or the concentrated conductive substances may be positioned as an electromagnetic shielding layer integrated with the hard coating layer.

According to another embodiment of the present invention, there is provided a method of manufacturing an optical filter, which includes preparing a light-transmissive base film; coating a liquid hard coating raw material on one surface of the base film, the hard coating raw material having conductive substances mixed therewith; and curing the hard coating raw material in the state that the conductive substances are concentrated in a region adjacent to the base film, and the hard coating raw material is formed between and on the conductive substances.

The conductive substances may have a specific gravity greater than that of the hard coating raw material.

The method may further include applying an electric field to move the conductive substances toward the region adjacent to the base film.

The hard coating raw material may include a fluorine-based polymer compound.

The hard coating layer may be formed to have a thickness of ¼ of the wavelength of a light passing therethrough.

The conductive substances may include conductive polymers or metal-based nano particles.

The conductive substances may include a material selected from the group consisting of polyanillines, polycarbonates, carbon nano tubes, carbon nano wires, and combinations thereof.

The method may further include forming a color coating layer on the one surface of the base film or another surface of the base film opposite to the one surface of the base film.

The forming of the hard coating layer may include forming the hard coating layer at the uppermost portion on the one surface of the base film.

In an optical film according to an embodiment of the present invention, a hard coating layer and an electromagnetic shielding layer are integrally formed, thereby simplifying a manufacturing process and increasing the yield of products. Further, the price of optical filters and a PDP employing such optical filters can be decreased.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a cross-sectional schematic view of an optical filter according to an embodiment of the present invention.

FIGS. 2A to 2C are schematic views sequentially illustrating a method of manufacturing the optical filter of FIG. 1.

FIG. 3 is a schematic view illustrating a method of manufacturing an optical filter according to another embodiment of the present invention.

FIG. 4 is a cross-sectional schematic view of an optical filter according to still another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

In the following description, a plasma display panel (hereinafter, may be referred to as a panel) or plasma display device which utilizes an electromagnetic shielding mechanism will be described as a flat panel display device to which an optical filter can be attached.

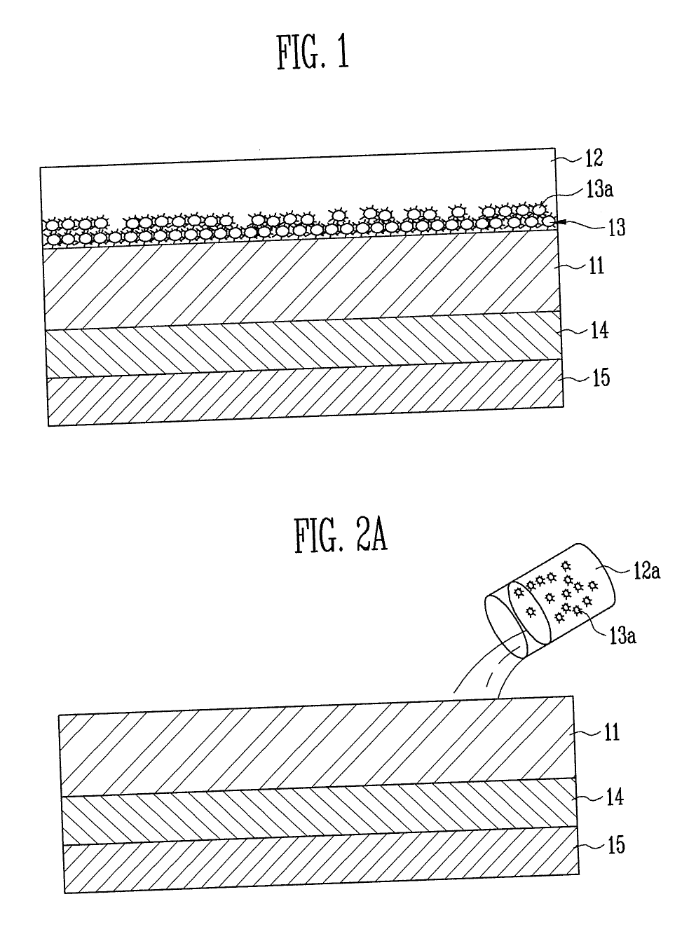

FIG. 1 is a cross-sectional schematic view of an optical filter according to an embodiment of the present invention.

Referring to FIG. 1, the optical filter includes a base film 11 and a hard coating layer 12 formed on one surface of the base film 11.

In this embodiment, the hard coating layer 12 has a structure in which conductive substances 13a are positioned in a region adjacent to the base film 11, and a hard coating raw material is infiltrated between the conductive substances composed of a plurality of conductive molecules. In other words, the hard coating layer 12 is disposed on one surface of the base film 11 and has a structure in which conductive materials are gathered (or concentrated) together in a region adjacent to the base film 11 and mixed with a hard coating raw material.

The conductive substances 13a are formed in the shape of a porous conductive layer and therefore serve as an electromagnetic shielding mechanism 13. The conductive substances 13a include conductive polymers or nano particles. Particularly, the conductive substances 13a may have a chain structure.

The hard coating layer 12 is formed on the one surface of the base film 11 so as to reduce (or prevent) external light from being reflected to the front of the panel and to protect the filter and the panel from external environment. The hard coating layer 12 may be formed to serve as an anti-reflection layer. Here, the anti-reflection layer is utilized to reduce (or minimize) loss of light passing therethrough and to reduce (or prevent) the reflection of light and to diffuse reflection of external light. In this case, the hard coating layer 12 is formed to a thickness of ¼ of the wavelength of a light passing therethrough on the base film 11. A transparent fluorine-based polymer, a silicon-based resin or the like may be used as a raw material of the hard coating layer 12.

In one embodiment, the hard coating layer 12 is formed to a thickness of between 2 and 7 μm so as to obtain an expected effect while not being too thick. The optical filter including the hard coating layer 12 has certain optical characteristics. These optical characteristics include a low haze of between 1 and 3%, a visible light transmittance of between 30 and 90%, a low external light reflectance of between 1 and 20%, a thermal resistance at or above a glass transition temperature, and a pencil hardness of between 1 and 3H.

The base film 11 is a base member of the optical filter, and is made of a material having a transmittance of between 80 and 99%, a low reflectance, a suitable thermal resistance and a proper solidity. Particularly, polyethylene terephthalate (PET) is a suitable material of the base film 11. However, the present invention is not thereby limited. For example, the material of the base film 11 may be or include polyethersulphone (PES), polyacrylate (PAR), polyetherimide (PEI), polyethylene napthalate (PEN), polyphenylene sulfide (PPS), polyallylate, polyimide, polycarbonate, triacetate cellulose (TAO), cellulose acetate propionate (CAP) and the like.

The optical filter may further include a color coating layer 14 and an adhesive layer 15, disposed on the other surface of the base film 11, e.g., the bottom surface of the base film 11 as viewed in FIG. 1.

The color coating layer 14 includes a coloring matter for color correction, near infrared shielding or orange wavelength absorption. The coloring matter includes a dye or pigment. For example, the coloring matter includes a nickel complex-based, phthalocyanine-based, naphthalocyanine-based, cyanine-based, diimmonium-based, squarylium-based, axomethine-based, xanthene-based, oxonol-based and/or azo-based material, which can shield a wavelength of between about 800 and about 1200 nm or shields or absorbs a wavelength of between about 585 and about 620 nm. The kind and concentration of the coloring matter may be determined based on the absorption wavelength and coefficient of a coloring matter, the color tone of a transparent conductive layer, the transmittance characteristic and transmittance required in the filter, and the like.

The adhesive layer 15 is formed on the other surface of the base film 11 so as to attach the optical filter onto the front of the panel. A material of the adhesive layer 15 may include an acryl-based, silicon-based, urethane-based and/or polyvinyl-based thermoplastic resin and/or a transparent adhesive and/or gluing agent such as a UV curing resin. For example, a silicon adhesive such as an acrylate-based resin and/or pressure sensitive adhesive (PSA) may be used as the material of the adhesive layer 15.

In addition, the adhesive layer 15 may include a coloring matter for color correction, near infrared shielding or orange wavelength absorption. In this case, the color coating layer 14 may be omitted.

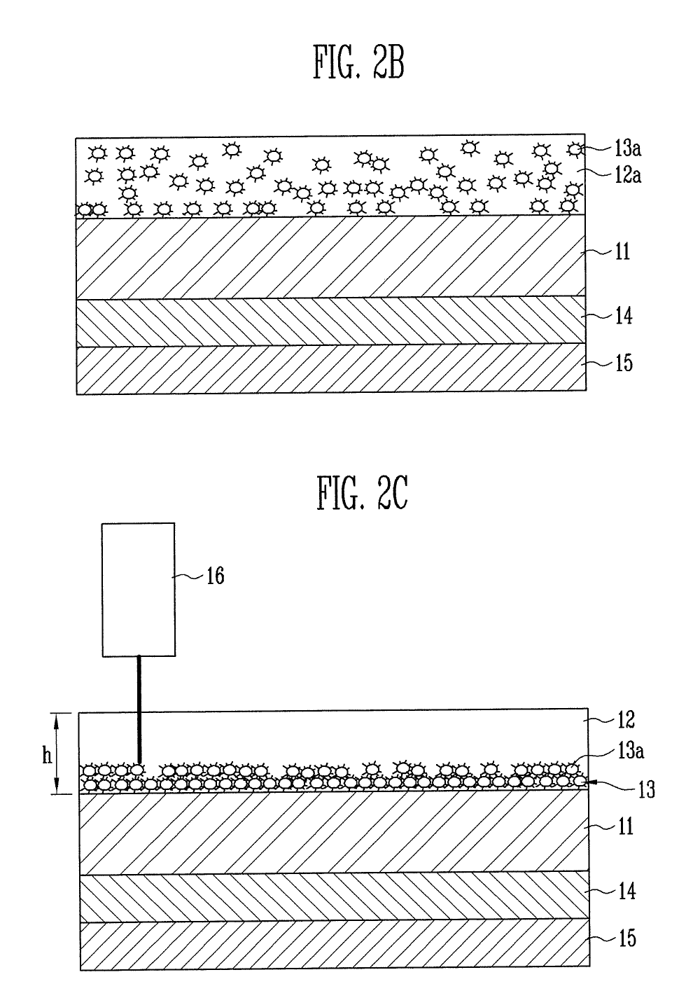

FIGS. 2A to 2C are schematic views sequentially illustrating a method of manufacturing the optical filter of FIG. 1.

In this embodiment, it is assumed that the base film 11 and the hard coating layer 12 are sequentially disposed when viewed from a direction in which gravity or a set (or predetermined) attraction force is applied.

Referring to FIG. 2A, a base film 11 is first prepared, and a hard coating raw material 12a is coated on the base film 11. The hard coating raw material 12a is coated on the base film 11 so that a final hard coating layer has a thickness having ¼ of the wavelength of a light passing therethrough (see FIG. 2C). Here, conductive substances 13a exist in the state of being mixed in the hard coating raw material 12a.

A fluoride-based polymer compound solution is utilized as the hard coating raw material 12a, and polyanilines are utilized as the conductive substances 13a. Since the polyanilines are conductive polymers having high electrical conductivity, they are suitable for conductive substances for electromagnetic shielding.

Referring to FIG. 2B, the conductive substances 13a coated on the base film 11 are concentrated on a region adjacent to the base film 11 due to the specific gravity difference between the conductive substances 13a and the hard coating raw material 12a. For example, the region adjacent to the base film 11 refers to a lower region of a hard coating layer in which the conductive substances 13a heavier than the hard coating raw material 12a are drawn (or sunk) toward by gravity.

The fluoride-based polymer compound solution utilized as the hard coating raw material 12a typically has a molecular weight of between about 5000 and about 10000, and the polyanilines utilized as the conductive substances 13a are polymerized with an oxidizer, e.g., (NH₄)₂S₂O₈ in the fluorine-based polymer compound solution to have a molecular weight of between 53000 and 60000. Therefore, the polyanilines mixed in the fluorine-based polymer compound solution are drawn (or sunk) toward a lower portion of the hard coating raw material 12a adjacent to the base film 11 by gravity.

Referring to FIG. 2C, after a set (or predetermined time elapses), the conductive substances 13a drawn (or sunk) toward the region adjacent to the base film 11 are mixed with the hard coating raw material 12a. In this state, the hard coating raw material 12a is cured utilizing a curing mechanism 16, thereby forming a hard coating layer 12. The curing mechanism 16 includes a device capable of allowing the hard coating raw material 12a to be cured by utilizing ultraviolet (UV) light.

When the polyanilines used as the conductive substances 13a are drawn (or sunk) toward the lower portion of the hard coating layer 12, the polyanilines having a chain structure are mixed with one another, thereby forming an electromagnetic shielding layer 13 having the shape of a porous conductive layer. Here, the shape of the porous conductive layer may be similar to a mesh shape. The hard coating raw material 12a exists between the conductive substances 13a constituting the electromagnetic shielding layer 13.

As described above, the hard coating layer 12 and the electromagnetic shielding layer 13 are concurrently (or simultaneously) formed, thereby simplifying a manufacturing process, increasing the yield of products and decreasing their price.

FIG. 3 is a schematic view illustrating a method of manufacturing an optical filter according to another embodiment of the present invention.

Referring to FIG. 3, the optical filter according to the embodiment of the present invention is manufactured by applying an electric field to a hard coating raw material 12a and conductive substances 13a, which are mixed and coated on a base film 11, so that only the conductive substances 13a are moved to a region adjacent to the base film 11.

In the method of this embodiment, an electric field applying mechanism 17 is separately used for applying the electric field. The electric field applying mechanism 17 includes a pair of electrodes 18a and 18b respectively disposed above and below the optical filter in a stacked direction, and a power supply 19 applying a voltage to the electrodes 18a and 18b.

Accordingly, when the conductive substances 13a are selected, it is not necessary to select only conductive polymers having a specific gravity greater than that of the hard coating raw material 12a as the conductive substances 13a, and various suitable conductive polymers may be used as the conductive substances 13a. Therefore, the selection range of the conductive substances 13a can be extended. Further, it is possible to reduce a time taken for the conductive substances 13a having a specific gravity greater than that of the hard coating raw material 12a to move to a lower portion of the hard coating raw material 12a.

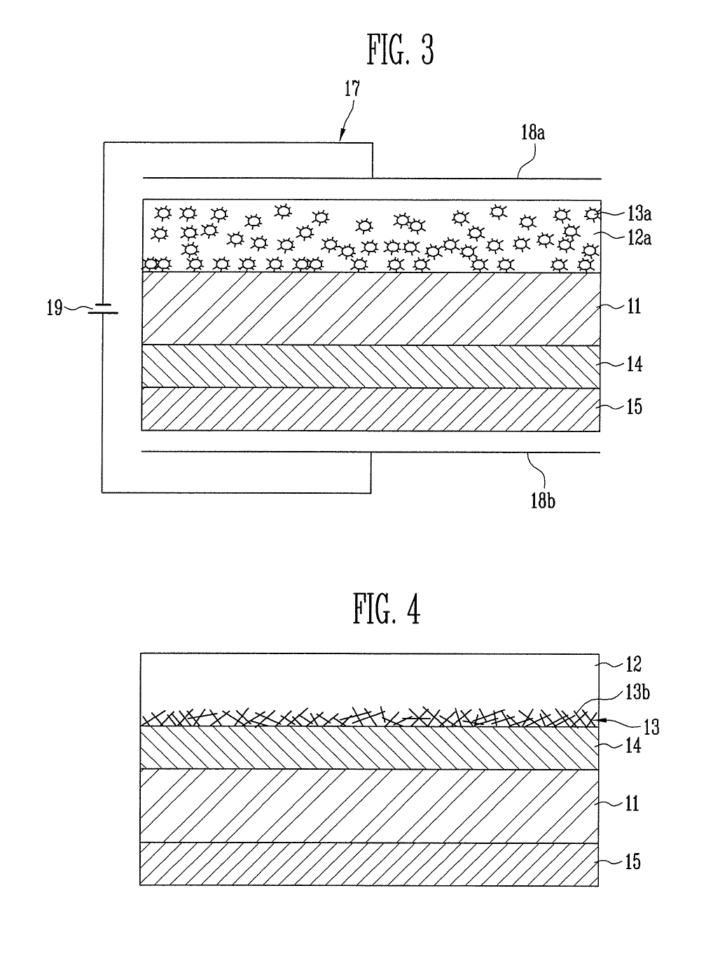

FIG. 4 is a cross-sectional view of an optical filter according to still another embodiment of the present invention.

Referring to FIG. 4, the optical filter according to the embodiment of the present invention utilizes conductive nano particles as conductive substances 13b rather than conductive polymers. The conductive nano particles include carbon nano tubes or carbon nano wires having a chain structure. Since the carbon nano tubes or carbon nano wires have a specific gravity greater than that of fluorine-based polymer compounds, they can be sunk in a fluorine-based compound solution by way of gravity.

In this embodiment, there is provided an optical film in which a hard coating layer 12 and an electromagnetic shielding layer 13 are concurrently (or simultaneously) formed through the same process as that of the optical filter of the aforementioned embodiment utilizing conductive polymers as the conductive substances. Briefly, carbon nano tubes and/or carbon nano wires are mixed in a fluorine-based polymer compound solution and then coated on a base film 11. Thereafter, if the carbon nano tubes and/or carbon nano wires are sunk to a lower portion of a hard coating raw material 12a after a set (or predetermined) time elapses, the hard coating raw material 12a is cured utilizing a curing mechanism, thereby forming a hard coating layer 12 and an electromagnetic shielding layer 13 formed beneath the hard coating layer 12.

Also, in the aforementioned embodiment of FIG. 1, the color coating layer 14 is formed on the other surface of the base film 11, i.e., the bottom surface of the base film 11 when viewed in FIG. 1. However, in the embodiment of FIG. 4, a color coating layer 14 is formed on one surface of the base film 11. In this case, the color coating layer 14 is interposed between the base film 11 and the hard coating layer 12 so that the hard coating layer 12 is disposed at the uppermost portion on the one surface of the base film 11. It is most effective in reducing (or preventing) reflection of external light and the like that the hard coating layer 12 is disposed at the uppermost portion of the optical filter.

Although it has been described in the aforementioned embodiments that conductive polymers or conductive nano particles are selectively utilized as the conductive substances, the present invention is not limited thereto. That is, in one embodiment, conductive polymers and/or metal-based nano particles are used together as the conductive substances.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. An optical filter comprising:
a base film; and
a hard coating layer on one surface of the base film and comprising conductive substances concentrated in a region adjacent to the base film.

2. The optical filter of claim 1, wherein the hard coating layer further comprises a hard coating raw material, and wherein the conductive substances have a specific gravity greater than that of the hard coating raw material of the hard coating layer.

3. The optical filter of claim 2, wherein the hard coating raw material comprises a fluorine-based polymer compound.

4. The optical filter of claim 3, wherein the hard coating layer has a thickness of ¼ of the wavelength of a light passing therethrough on the base film.

5. The optical filter of claim 3, wherein the conductive substances comprise conductive polymers or metal-based nano particles.

6. The optical filter of claim 5, wherein the conductive substances have a chain structure.

7. The optical filter of claim 5, wherein the conductive substances comprise a material selected from the group consisting of polyanillines, polycarbonates, carbon nano tubes, carbon nano wires, and combinations thereof.

8. The optical filter of claim 1, further comprising a color coating layer on the one surface of the base film or another surface of the base film opposite to the one surface of the base film.

9. The optical filter of claim 1, wherein the hard coating layer is an anti-reflection layer.

10. The optical filter of claim 1, wherein the concentrated conductive substances are positioned as an electromagnetic shielding layer.

11. The optical filter of claim 1, wherein the hard coating layer is an anti-reflection layer, and the concentrated conductive substances are positioned as an electromagnetic shielding layer integrated with the hard coating layer.

12. A method of manufacturing an optical filter, comprising:
preparing a light-transmissive base film;
coating a liquid hard coating raw material on one surface of the base film, the hard coating raw material having conductive substances mixed therewith; and
curing the hard coating raw material in the state that the conductive substances are concentrated in a region adjacent to the base film, and the hard coating raw material is formed between and on the conductive substances.

13. The method of claim 12, wherein the conductive substances have a specific gravity greater than that of the hard coating raw material.

14. The method of claim 12, further comprising applying an electric field to move the conductive substances toward the region adjacent to the base film.

15. The method of claim 12, wherein the hard coating raw material comprises a fluorine-based polymer compound.

16. The method of claim 15, wherein the hard coating layer is formed to have a thickness of ¼ of the wavelength of a light passing therethrough.

17. The method of claim 15, wherein the conductive substances comprise conductive polymers or metal-based nano particles.

18. The method of claim 17, wherein the conductive substances comprise a material selected from the group consisting of polyanillines, polycarbonates, carbon nano tubes, carbon nano wires, and combinations thereof.

19. The method of claim 12, further comprising forming a color coating layer on the one surface of the base film or another surface of the base film opposite to the one surface of the base film.

20. The method of claim 12, wherein the forming of the hard coating layer comprises forming the hard coating layer at the uppermost portion on the one surface of the base film.
